(19) United States
(12) Patent Application Publication
(10) Pub. No.: US 2007/0288275 A1
(43) Pub. Date: Dec. 13, 2007

(54) IT SERVICES ARCHITECTURE PLANNING AND MANAGEMENT

(75) Inventor: Dinesh Kumar, Chadds Ford, PA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/423,863

(22) Filed: Jun. 13, 2006

(51) Int. Cl. G06F 17/50

(52) U.S. Cl. 705/7

(57) ABSTRACT

Technology for evaluating an IT enterprise is provided. The technology models all information technology or solutions as services which are provided to a business organization. Each service can itself consume and be consumed by other services. Using a defined model service portfolio, the business goals of an organization are mapped against the portfolio to derive a services portfolio for a given business. Real world constraints such as budgeting and existing technology are then applied against the developed portfolio to derive a service plan.

### BACKGROUND

Information Technology (IT) management must continuously deliver new capabilities, reduce cost, manage business risk and improve service levels. IT service providers and managers must plan and create solutions that solve a business organization's needs today and deliver future needs a lower cost.

There have been numerous attempts to define an IT architecture and planning processes. These include the Zachman framework, The Open Group Architecture Framework (TOGAF), and The Department of Defense Architecture Framework (DoDAF), amongst others. Similarly, there are models and tools for IT physical asset management, configuration management and service-level monitoring. Many consulting companies and organizations provide enterprise architecture services to define the target state and plan the migration to the target state. Existing enterprise architecture frameworks are primarily rooted in IT systems development. They are process-centric, focusing on architecture planning and enforcement activities and organization structure. These systems are generally horizontal in nature, creating conditions where everything must be defined and agreed upon before any action or implementation. In addition, they tend to be development-centric, ignoring IT life cycle such as operations, and project-focused, thereby being a follower to business requirements.

In dealing with the above issues regarding existing frameworks, IT organizations may find these approaches are difficult and challenging to execute. They can also add significant cost to a project by requiring a number of meetings and reviews.

### SUMMARY

Technology for modeling an IT enterprise is provided. The technology models all information technology capabilities as a services portfolio which can be provided to a business organization. Each service can itself consume and be consumed by other services. Using a defined model service portfolio, the business goals of an organization are mapped against the portfolio to derive a services portfolio for a given business. Real world constraints such as budgeting and existing technology are then applied against the developed portfolio to derive a service vision and plan.

In one aspect the invention includes a method of planning an information technology architecture for a business organization. The method includes the steps of: defining each technology or solution in an information technology architecture as an information technology (IT) service; mapping the attributes to other services; determining future business goals for the organization and for each goal, the IT services required to support such goal; and creating a services portfolio comprising an organization of at least some of said information services.

In another aspect, a method of planning an information services technology architecture is provided. The method includes the steps of: building a model services portfolio for a business enterprise comprising a set of services defined by functional capabilities and attributes; gathering a series of business goals for the organization; and creating a modified business services portfolio based on the forward looking business goals

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flowchart illustrating a first method in accordance with the present invention.

FIG. 2 is a flowchart illustrating a second method in accordance with the present technology.

FIG. 3 is a diagram illustrating the definition of a service in accordance with the technology herein.

FIGS. 4A and 4B are examples of a first service definition for a directory service.

FIGS. 5A and 5B are examples of a second definition of a service for a security service in accordance with the present invention.

FIG. 6 is an example of a first or preliminary service portfolio defined in accordance with the methodology discussed herein.

FIG. 7 is an illustration of a method for applying business goals to the definitions prescribed in FIGS. 3-5.

FIG. 8A is an example of a modified service portfolio for a particular organization.

FIG. 8B is an example of a service definition for a directory service for a particular organization.

FIG. 9 illustrates a plain topology in accordance with the present methodology.

FIG. 10 illustrates a gap analysis report in accordance with the present technology.

### DETAILED DESCRIPTION

The present technology includes a process and information model which allows for the evaluation of the capabilities and attributes of an IT Service. The technology addresses the limitations of existing enterprise architectures and enables IT to lead the business in leveraging technologies for innovation and competitive differentiation. The solution supports IT life cycle, covering IT operations and governance and enables planning for change as well as measurement of change. In addition, a consistent model is provided across industries and customer segments.

In one aspect, the present process drives actions through an information-centric, rather than a process-centric model. In particular, the solution defines enterprise architecture framework as combination of an information model, helpful for collecting, organizing, analyzing, measuring and communicating information needed by various stakeholders to make decisions quickly, and a process model, helpful for implementing consistent, predictable set of activities and workflows for making timely decisions.

In one aspect, the capabilities and attributes of an IT service are linked to one or more business processes and capabilities. In another aspect, capabilities and attributes are connected with other services, and physical configuration and monitoring information of the service. The information model provides the translation layer and glue between business and IT capabilities and operations.

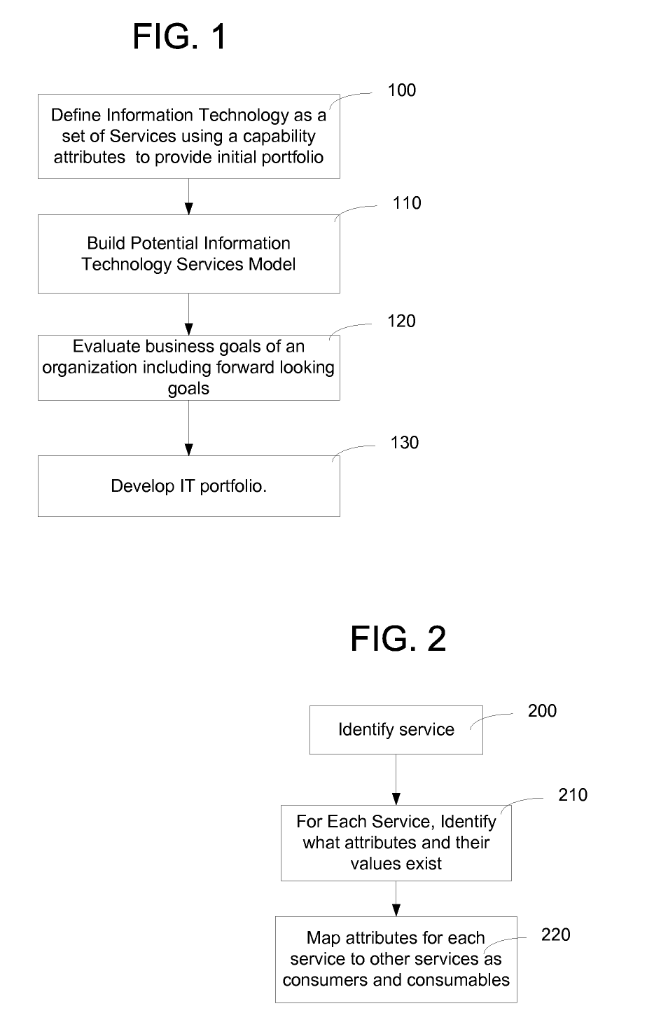

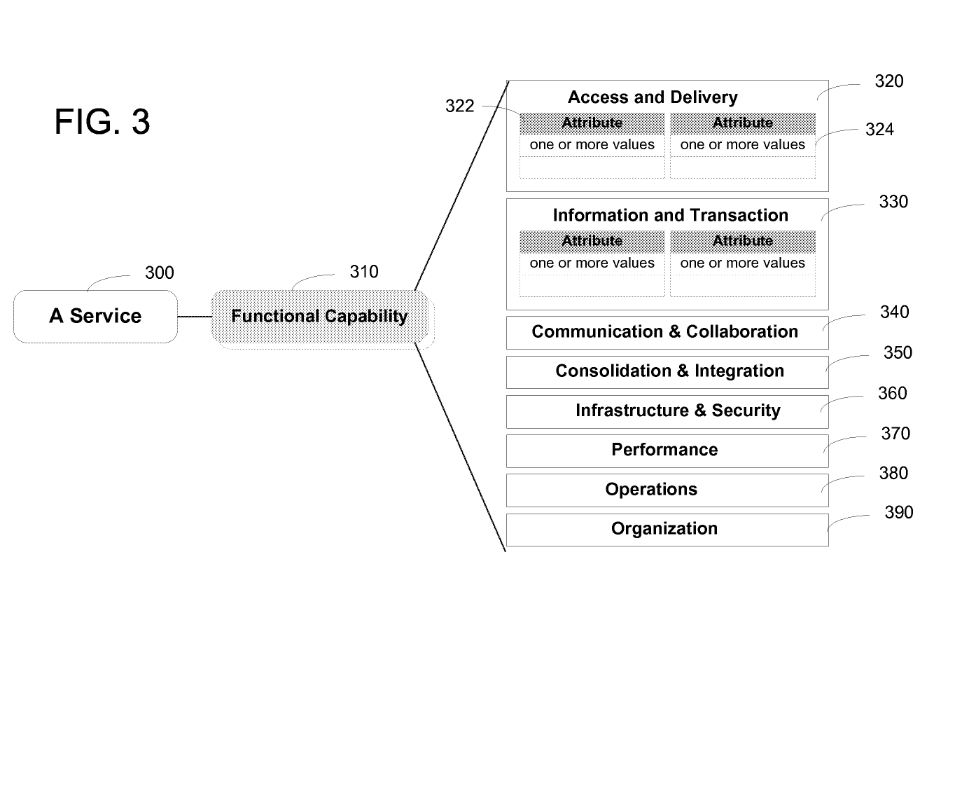

FIG. 1 is a flowchart depicting a general method in accordance with the methodology. At step 100, for any given information technology planning process, each aspect of the technology is defined as a service. The particular aspects of step 100 are explained with respect to FIGS. 2 and 3. At step 110, an information services model of all available potential IT services is constructed. The information technology(IT) model represents a taxonomy structure of the capabilities and attributes of an IT service. One or more IT capabilities are provided by a technology or solution. A service may provide one or more IT capabilities. A service may require one or more technologies or solutions.

A preliminary or potential model is created at step 110, representing all of the possible services available in an IT model. This includes defining the capabilities and attributes of one or more IT services, and linking these capabilities and attributes to one or more business processes and capabilities. At step 120, the business goals of a particular organization or enterprise are evaluated. In this context, evaluating the business goals includes determining the future objectives and plans for a business organization in terms of the type of business the organization is in and the goods or services provided by the organization. At step 130, the IT portfolio for the organization is developed by applying the business objectives and needs of the enterprise to the preliminary portfolio, to provide a portfolio tailored to the organization, as well a gap analysis using an architecture planning structure. During this analysis, the capabilities and attributes of each IT service is mapped with the physical configuration and monitoring information.

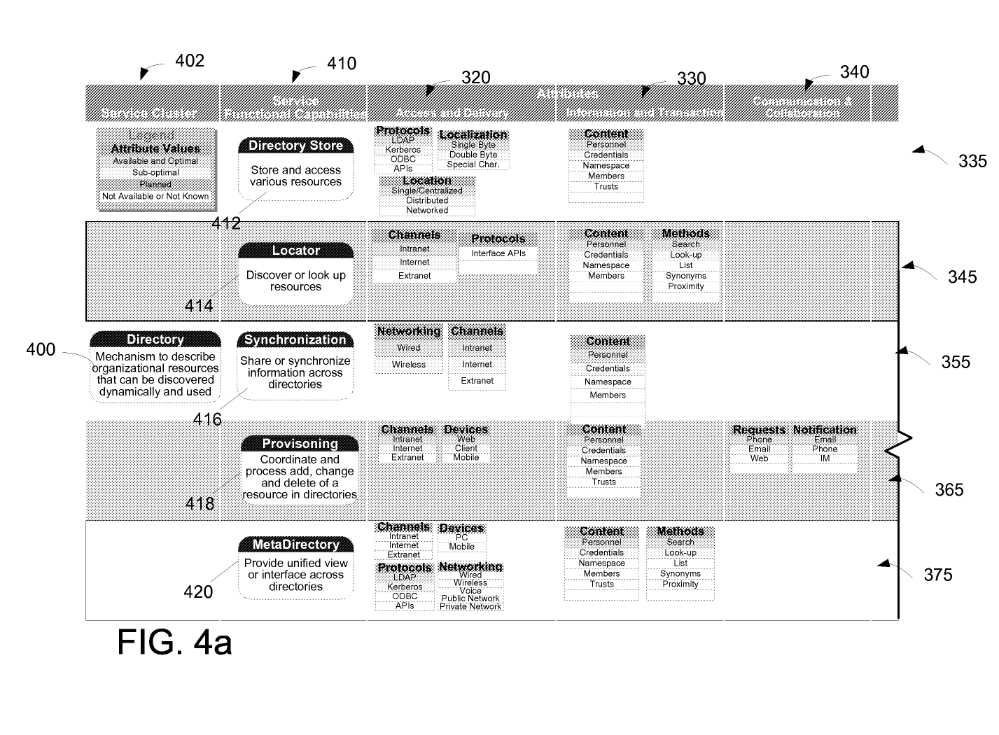

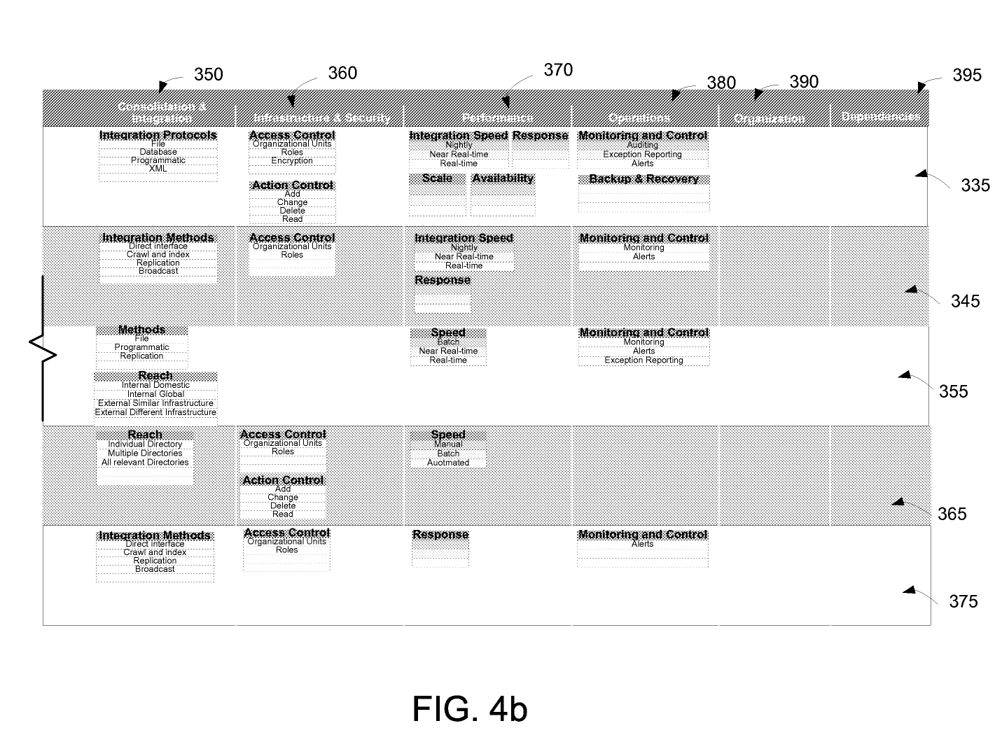

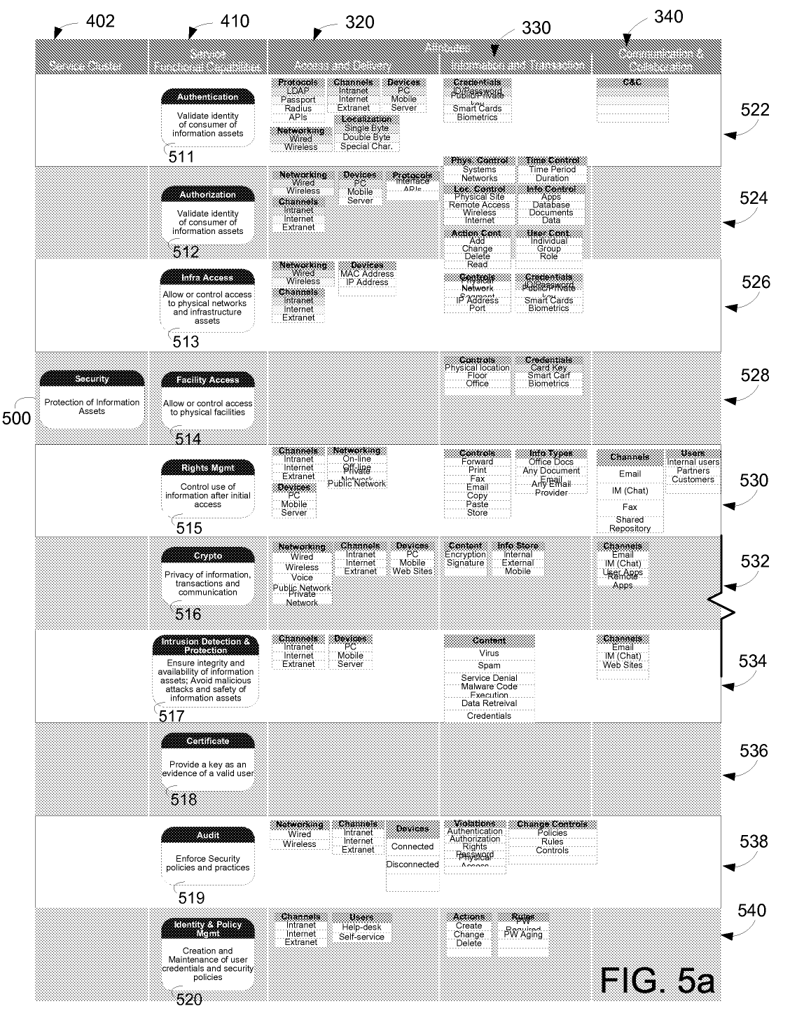

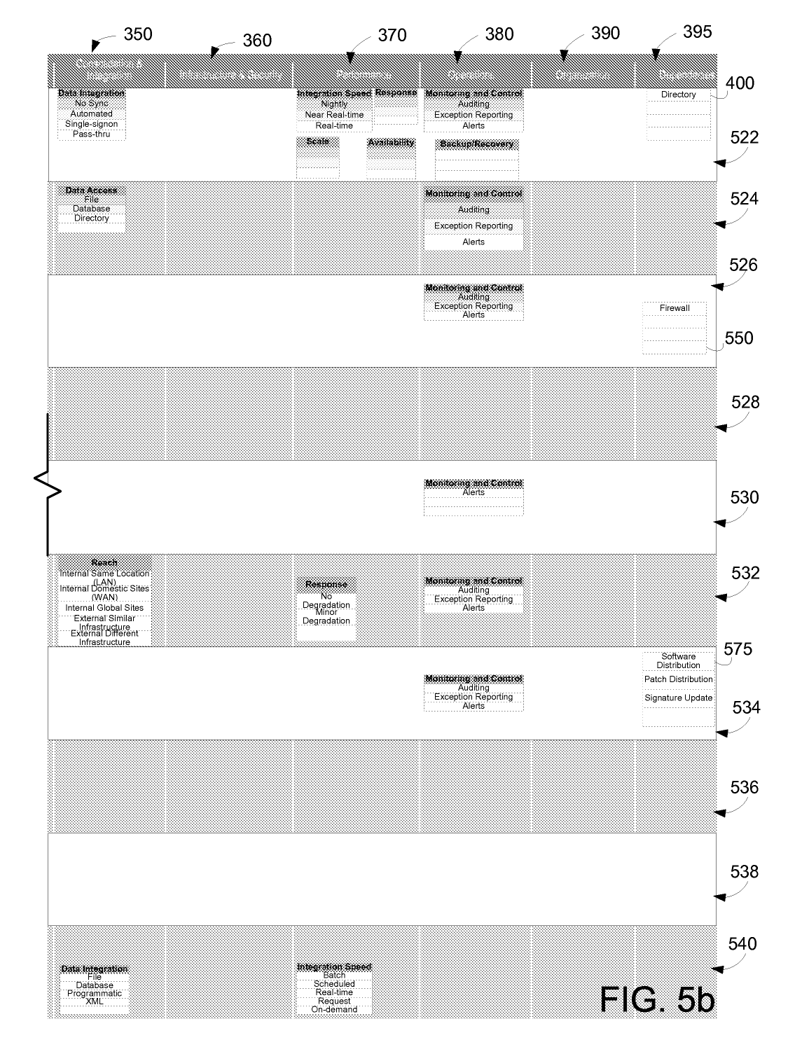

FIG. 2 is a flowchart depicting step 100 of FIG. 1. In general, a service is identified at step 200 and at step 210, for each service, the functional capabilities are specified using the structure outlined in FIG. 3. For each functional capability of each service, one or more attributes are specified. Examples of service definitions are shown in FIGS. 4a-4b and 5a-5b. For each service, at step 220, the attributes are then mapped to other services on which they are dependent. Hence, each service includes within it's definition other services which are themselves consumers and consumed by a defined service. Optionally this mapping is performed manually or by a computer implemented process.

FIG. 3 illustrates a model for a definition of a service. In this context, a service is defined as a tangible set of capabilities with well-defined interfaces for its consumers to consume or integrate. Typically, a service has more than one consumer, has its own life cycle and ownership, is separate from its consumers, and has defined performance metrics. A service may aggregate, embed or integrate other services, in order to provide “marketable” or “higher-level” set of capabilities. A service may have multiple grades based on different values of the capability attributes and implementation characteristics. For example, a content publishing service may have two grades—file-based and portal-based. A service may have multiple implementation (physical) instances. A service may be a business-centric or IT-centric service.

As shown in FIG. 3, a service 300 includes a functional capability 310. Each functional capability allows one to accomplish a particular task or function, and is valued by its customer. A capability has one or more attributes classified as Access and Delivery 320, Information and Transaction 330, Communication and Collaboration 340, Consolidation and Integration 350, Infrastructure and Security 360, Performance 370, Operations 380 and Organization 390.

A service may provide one or more capabilities with specific attribute values. A capability may have dependencies on other capabilities. An attribute of a capability may in fact be a capability provided by another service. Capabilities may be aggregated into higher-level capabilities. This provides an advantage in that actual managers—IT manager and business managers—are not exposed to unnecessary detail or complexity. A capability may not change over time, its attributes may. The capability is implementation or technology agnostic. The capability attributes are specific enough to evaluate alternative approaches to implement the capability.

Attributes define the characteristics of a capability. An attribute may provide additional details about a capability itself or how the capability interacts with the rest of the system. Each attribute may have multiple values. For example, authentication of a user is a capability. Types of user credentials are included under attributes; and in that case user-id, smartcard, PKI, biometrics are the values. A service or an implementation of a service may support one or more values of an attribute. An attribute of a capability may in fact be a capability provided by another service. Attributes are categorized into following categories.

Access and Delivery attributes include those attributes specific to questions like who, where and how a consumer can access the capability. It may include physical locations, devices, access channels, networks, interfaces, and the like.

Information and Transactions attributes include attributes specific to the content (information) provided, used or managed by the capability and actions (transactions) performed on the content. Common attribute classes—content type, content language, content format, rules, configuration, actions and the like.

Consolidation and Integration attributes include attributes specific to the ways in which information can be consolidated or disseminated; it also includes information on how it can be integrated with other processes, activities i.e. other capabilities in the services portfolio model. Some of the mechanisms may be the capabilities provided by other services. In such case, the attribute values identify the support or use of other capabilities.

Communication and Collaboration attributes include attributes specific to the ways information can be communicated to other people or collaborated between people inside or outside the organization.

Infrastructure and Security attributes include attributes specific to how content and access can be secured or controlled, what infrastructure components can be used to provide the capability e.g. data store, middleware, platforms and the like.

Performance attributes include attributes specific to service levels in terms of quality, availability, scalability, response time, throughput and the like.

Operations attributes include attributes specific to the on-going operation or continuity of the capability, particularly the ways this capability can be monitored, archived and restored.

Organization attributes include attributes specific to the governance, people and financial metrics.

FIGS. 4a and 4b show a first example of a defined service. The definition provides a structure that allows the organization, communication, evaluation and planning of any service. The model captures functional and non-functional information about a service. The model should keep up-to-date with new capabilities and attributes as technology evolves or new solutions emerge.

FIGS. 4A and 4B illustrate a service definition for a directory service. (FIGS. 4A and 4B are to be read side by side as shown in the legend accompanying FIG. 3.)

For each service 402, functional capabilities 410 and attributes 320, 330, 340, 350, 360, 370, 380, 390 are organized as columns on an organization matrix. Rows 335, 345, 355, 365 and 375 provide containers for each of the functional capabilities 410 defined for a directory service. In examples shown in FIGS. 4A and 4B, an exemplary directory service 400 is defined as a mechanism to describe organizational resources that can be discovered dynamically in use.

The service has five defined functional capabilities. These include: a directory store 412 to store and access various resources; a locator 414 to discover and look up resources; a synchronization capability 416 to share and/or synchronize information across directories; a provisioning capability 418 to coordinate and process, add, change and delete of resources in directories; and a meta directory 420 capability, to provide unified view or interface across directories. For each of the functional capabilities 412, 414, 416, 418 and 420, individual attributes are listed in row as fashion and organized in the structure. At this particular point in the method, the goal in organizing and defining each service is to provide all the potentially available services available to the information technology directory service.

The attributes of the directory store functional capability 412 are organized in row 335 for each of the respective defined attribute categories shown in FIG. 3. For example, directory store functional capability 412 includes a number of access and delivery attributes including protocols, localization and location. Possible protocols include LDAP, Kerberos, OBDC, and APIs. Other attribute values are shown in their respective categories for each respective functional capability.

In a further aspect of the model, each of the attribute values can be evaluated and organized using various evaluation models, such as, availability of the attribute value, quality of the implementation, organizational scope, technology used and the like. In the example shown in FIG. 4A, the attribute values are evaluated based on availability and quality of the implementation. The evaluation criteria in this example is available and optimal, suboptimal, planned, and not available or not known. The access and delivery attribute of a directory store, the LDAP protocol is available and optimal, Kerberos is indicated as sub-optimal, and OBDC and APIs are either not available or not known. It will be understood that the text and type of assessment in legends shown in FIG. 4A can be changed depending upon the purpose and scope of the assessment. Likewise, directory store functional capability 412 includes a content attribute in the information and transaction category of attribute. The attributive values defined are personnel, credentials, name space, members, and trusts. As indicated in FIG. 4A there are no communication or collaboration attributes for the directory store functional capability 412, however, there are consolidation and integration attributes (integration protocols), infrastructure and security attributes (access control and action control attributes), performance attributes (integration speed, response scale and availability), and operation attributes (monitoring and control and backup and recovery attributes).

An additional column 395 indicates the dependencies of a given service on other services. In this example, there are no dependencies indicated. An organization may decide to organize the capabilities and attributes differently. New technologies and solutions may introduce new functional capabilities, new attributes and new values.

A more complex example of a service is shown for a security service illustrated in FIGS. 5A and 5B. (FIGS. 5A and 5B are meant to be read side-by-side as a single organizational grid and they are similar to that of FIGS. 4A and 4B.)

A security service 500 is defined by a number of functional capabilities 511-520. An authentication capability 511 validates the identity of the consumer of the information assets. An authorization capability 512 validates the identity of the consumer of the information assets. An infra-access capability 513 allows or controls access to physical night works and infrastructure assets. A facility access capability 514 allows or controls access to physical facilities. A rights management capability 515 controls the privacy of information, transactions and communication. A crypto capability 516 provides secure communications via cryptography. An intrusion detection and protection capability 517 ensures the integrity and availability of information assets and avoids malicious attacks and safety of the information assets. A certificate capability 518 provides a key as evidence of a valid user. An audit capability 519 forces security policies and practices. An identity and policy management capability 520 allows for the creation and maintenance of user credentials and user policies.

Like the definition outlined in FIGS. 4A and 4B, each of the capabilities 511-520 include one or more attributes organized row wise in rows 522, 524, 526, 528, 530, 532, 534, 536, 538 and 540.

In this definition, it is noteworthy that security service 500 has a number of dependencies attributes shown in column 395. For example, the authentication capability 511 has a dependency on the directory service 400. Likewise, infra access capability 513 has a dependency on a firewall service 550 and an intrusion detection 517 has a dependency on software distribution, patch distribution, and signature update service 575. Other various attribute values are indicated in the taxonomy shown in FIGS. 5A and 5B. It will be recognized that a series of taxonomies for any IT service can be defined in a similar manner.

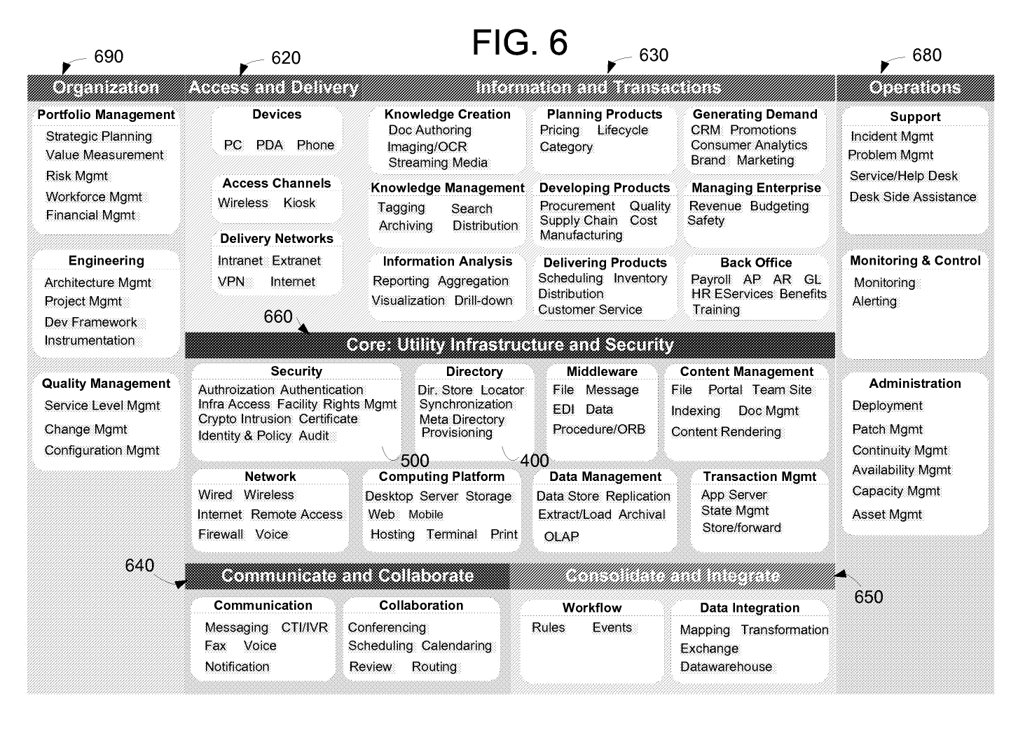

FIG. 6 illustrates a preliminary or initial portfolio 600 which is created based on a service definition of information technology (step 110 of FIG. 1). In one implementation the initial portfolio can be used to evaluate any business organization as described below.

The services portfolio FIG. 6 is organized in line with the attribute definitions 320, 330, 340, 350, 360, 370, 380, and 390 which make up each service definition. Each of the services, for example services 500 and 400 are listed under the respected attribute category (organization 690, access and delivery 620, information transaction 630, operation 680, infrastructure and security 660, communication and collaboration 640, or consolidation and integration 650) in the services portfolio. As noted above, the organization of each of the services into the particular attribute categories reduces the complexity of the structure and provides an overall map for information technology providers.

Each service is described in terms of its functional capabilities. For example the directory service as described in terms of the locater synchronization meta directory and provisioning capabilities outlined in FIG. 4A. Likewise the security service is described in terms of authorization authentication, internet access, facility rights, management, cryptology, intrusion, certificate, identity and policy, and auditing. Each of the other services shown in FIG. 6 are likewise described in terms of their functional capabilities.

As capabilities and attributes are actually provided by various IT services, FIG. 6 provides an example of organizing various services. The organization services include a portfolio management service, an engineering service, and a quality management service. The access and delivery services include devices, access channels, and delivery networks. Information and transaction services 630 includes knowledge creation, planning products, generating demand, knowledge management, developing products, managing enterprise, information analysis, delivering products, and back office services. Operations 680 includes support, monitoring and control, and administration. Utility infrastructure and security include the core services for any information technology environment. These include security, directory services, middleware, Content management, networking, computing platforms, data management, and transaction management. The communication and collaboration services 640 include communication services such as messaging, CTI/IVR, fax, voicemail and notification, and collaboration services such as conferencing, scheduling, calendaring, review and routing. Consolidation and integration services 650 include workflow and data integration services.

As noted from the organizational structure of FIG. 6, the core services 660 provide a foundation for the access and delivering information and transaction services as well as the communication and collaboration and consolidation and integration services. The organization services drive the business management of the information technology services portfolio, while the operations group 680 drives on-going maintenance and support of the information technology services portfolio. Some of the services may be aggregation of other services. For example, communication service is an aggregation of messaging, Fax, Voice, CTI/IVR, and notification services. The level of granularity or aggregation depends upon the level of management control required and complexity.

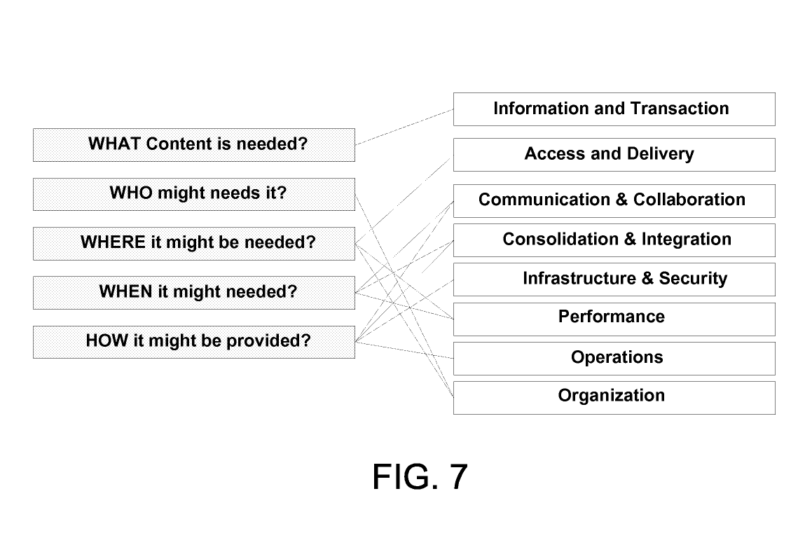

FIG. 7 illustrates a process for mapping the business needs of an organization to the Services portfolio developed above (step 120 of FIG. 1). Business managers may not communicate long-term strategy to IT managers. For example, business rarely asks for IT infrastructure capabilities, while every business capability is highly dependent on the infrastructure. FIG. 7 shows a simple mechanism to understand future business needs and identify appropriate IT capabilities needed to support them.

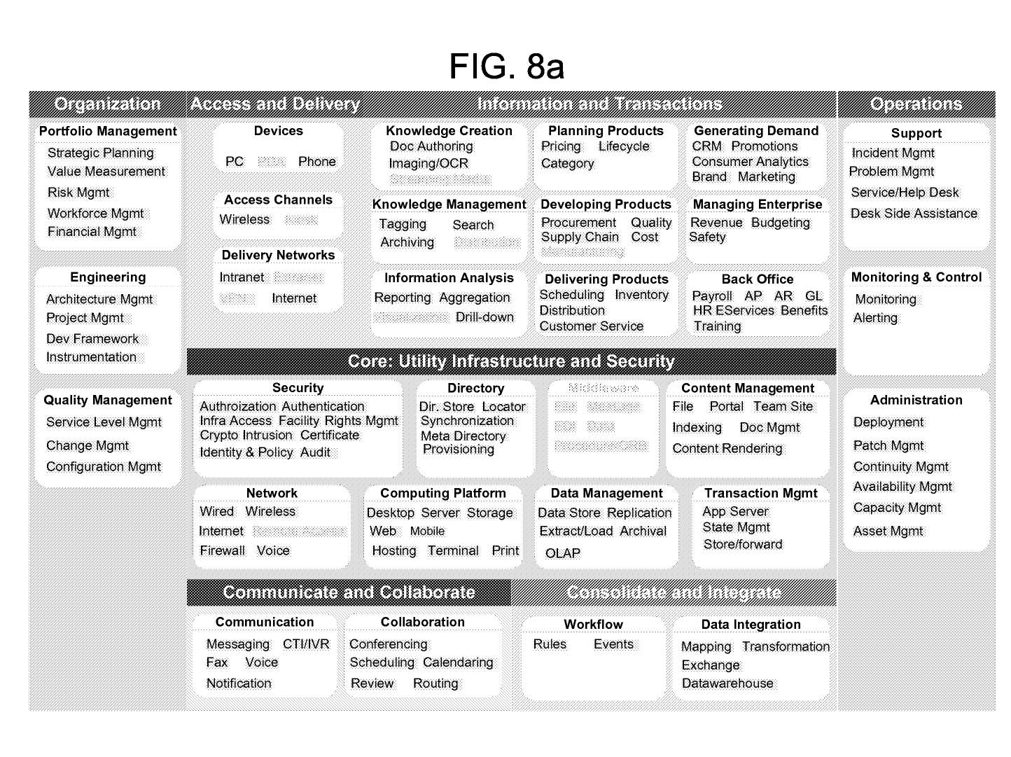

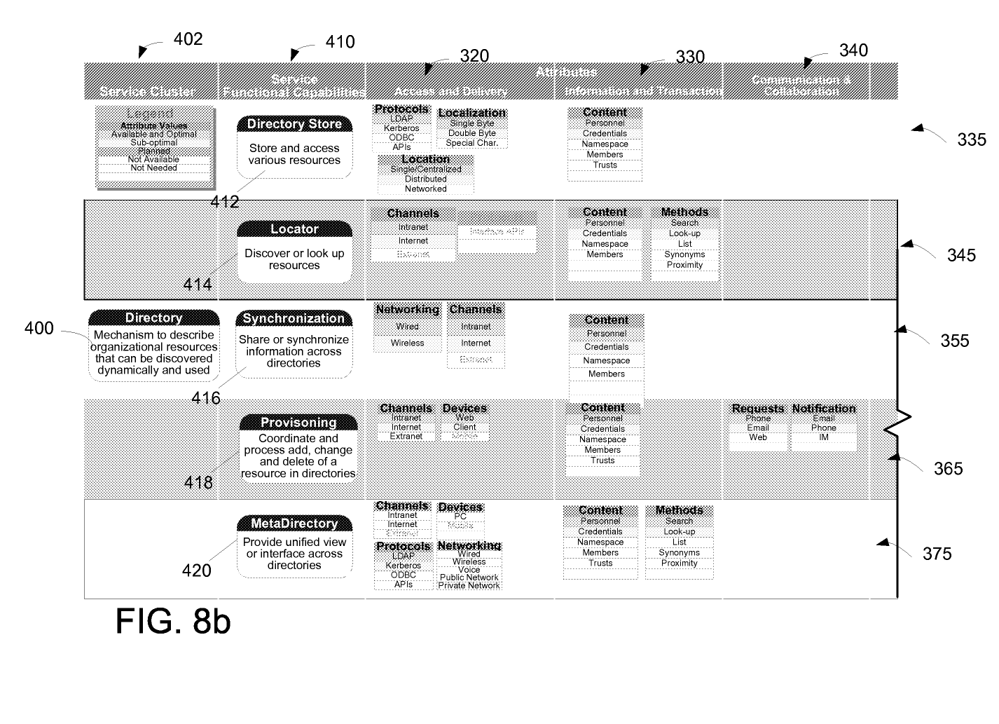

Core business activities are identified in that companies still need to research customer needs, build products to address those needs, market them, and support customers after the sales. There are five (5) attributes of a business activity which have changed and will change over time. The changes in these attributes drive the need for new IT capabilities. As illustrated in FIG. 7, the business attributes include asking “what content is needed”, “who might need the content”, “where it might be needed”, “when it might be needed” and “how it might be provided?” Each of these questions maps directly onto one of the categories in the portfolio map generated in FIG. 6 and the answers to such questions thereby modify the system portfolio to provide a modified portfolio specific to the business as shown FIG. 8 below.

In FIG. 7, each of the specific business attributes are explained as follows. The analysis of “what content” addresses the need that, over time, business activity may require different information or perform different transactions. For example, one may want to know not only current patient diagnosis but also the correlation of the diagnosis compared to rest of the population. This information from the business maps directly to the information and transaction services in the services portfolio model of FIG. 6 and information and transaction attributes of functional capabilities of services as in FIG. 3.

The analysis of who might need content addresses the need that different people may perform the same business activity within or outside an organization. Many of the activities of a sales person may, for example, now performed by the customer. Hence, customers may need access to sale and transaction information from the business. This information from the business maps directly to the organization attributes of the services portfolio model of FIG. 6.

The analysis of where content might be needed addresses the issue that the location of the activity may change over time. What used to be done in an office can now be done while on the road. This information from the business maps to the access and delivery, performance and organization attributes of the services portfolio model of FIG. 6.

The analysis of when content might be needed addresses the issue that the timing and speed of the activity will change over time. What used to be a night batch report now is available instantly on-demand. This information from the business maps to the communication and collaboration, consolidation and integration, and performance attributes of the services portfolio model of FIG. 6.

Finally, the analysis of how content might be needed addresses the user experience in accessing and using the content will change. Rather than having different user interfaces and sign-on, people want to have consistent interface with single sign-on. This information from the business maps to the communication and collaboration, consolidation and integration, infrastructure and security and operations attributes of the services portfolio model of FIG. 6.

These five questions or attributes can help any architect or strategy planner to envision what might change in a business activity over time.

Applying the analysis of FIG. 7, one will derive a modified services portfolio model for a business such as that shown in FIG. 8A (step 130 of FIG. 1). As shown therein, for example, only a limited number of devices and access channels and delivery networks are provided based on the analysis of FIG. 7. Those functional capabilities which were eliminated from the preliminary model are shown in grayed out form. For example, where the business goals of an organization do not require access from outside an organization on small, hand-held devices, the PDA access to content, as well as VPN and Extranet services may be removed. Likewise, other decisions have resulted in the removal of the functional capabilities of streaming media, distribution of knowledge management, Manufacturing of developing products, visualization of information analysis and remote network access have been removed. Optionally, an entire service can be removed. In FIG. 8A, the analysis of FIG. 7 shows that no middle ware application is necessary in this enterprise, so the service is removed.

FIG. 8B shows a modified directory service definition after performing the analysis of FIG. 7. Like the modified services portfolio model, the service definition of any service may change based on the business analysis. In the example in FIG. 8B it will be noted that the extranet values and some mobile device values have changed consistent with the changes made to FIG. 8A, based on the needs of the business in not requiring PDA, VPN or extranet support. It will be understood that any of the defined services may change consistent with FIG. 7 and FIG. 8B is merely exemplary.

Once the services portfolio model is complete for an organization, additional analyses and reporting may be required. For example, a gap analysis is required to determine how to achieve a particular IT service structure given a present state of the structure.

The foregoing model and analysis has thus far been concerned primarily with the perspective of defining and planning IT Services. In this perspective, there are no direct reference to technical design, physical implementation, and actual business activities. This perspective also does not include selection and prioritization of service capabilities based on organizational investment criteria.

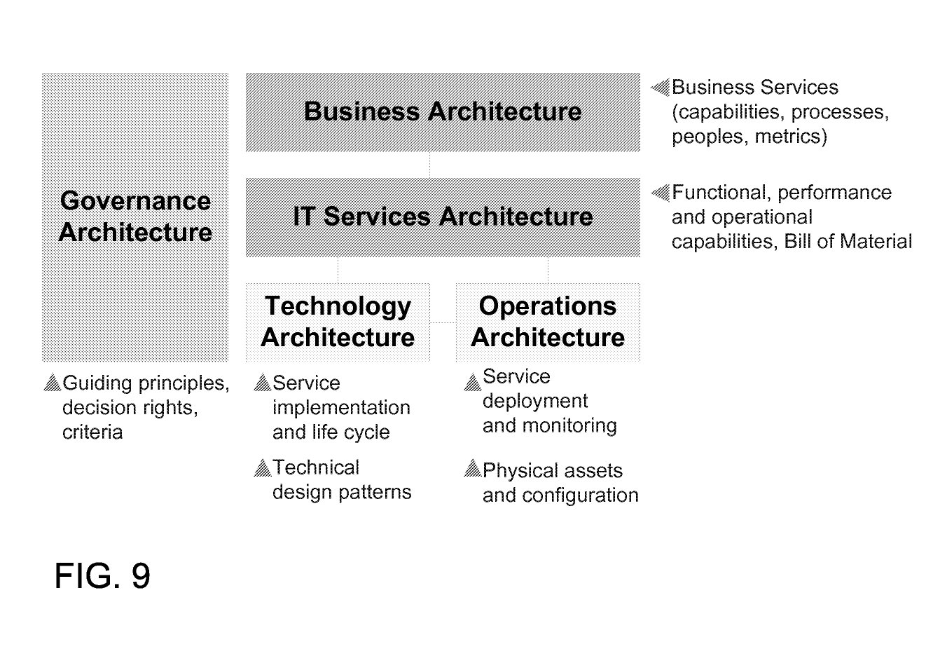

FIG. 9 defines the overall enterprise architecture model, designed to support IT life cycle and on-going measurement, and provides a framework for linking service capabilities to business, technology implementation and physical operations, as well as application of constraints to the planning model generated by the process of FIG. 1.

FIG. 9 defines the architecture model as broken down into governance architecture, business architecture, the IT services architecture, a technology architecture and an operations architecture.

In this context, the capabilities a given service can provide are known. Collectively, IT services with their capabilities and attributes make up IT Services architecture.

Business architecture maintains information about the business environment, including business capabilities and activities. Based on the business understanding, one also knows where the business capabilities might be and can determine the gap between what needs to be delivered and what is presently available. For example, sales will say “we need sales functions on the road” and this will translate to a check of the service model to determine what information is necessary to provide to the salesperson, and what services provide that information to them. Business architecture is linked to IT services architecture as business is consumer of IT services.

Technology architecture maintains information about the technical or technology design for an IT service. A service may have a technical design for each technology used.

Operations architecture maintains information about the physical implementation the technology design of the service. It also maintains the information for on-going administration and monitoring of the service.

The governance architecture provides a set of principles, a structure to manage portfolio of IT Services, and mechanism to enforce policies. The governance architecture provided the necessary organizational context and constraints in developing the statement of direction for an IT Service.

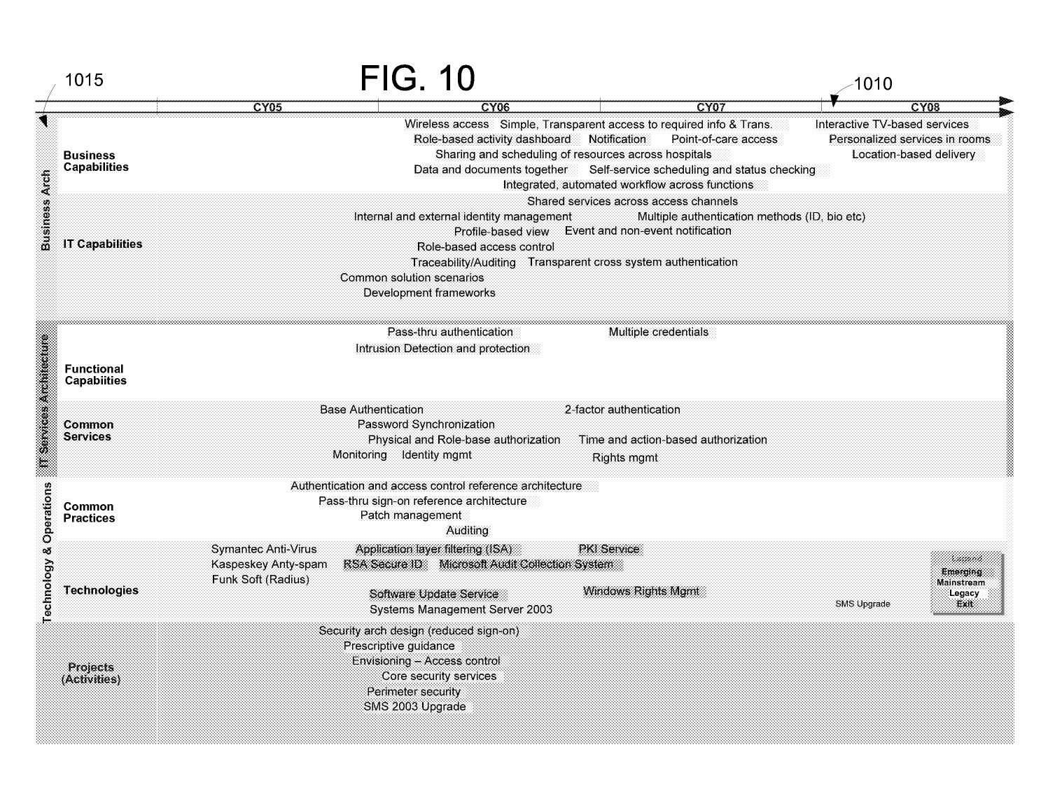

FIG. 10 shows a statement of direction for a security information service. FIG. 10 show, for example the utility infrastructure and security information relative to time.

FIG. 10 illustrates the result of applying the architecture model of FIG. 9 to the current state of an enterprises information technology to output a gap analysis between the actual state of a given service or technology and the desired state of the service or technology. A timeline 1010 indicates a number of calendar years CY05, CY06, CY07 and CY08. The vertical axes 1015 indicates classifications by business architecture, IT services architecture, technology and operations architecture, and projects or activities to be performed by the IT service provider to deliver the desired information technology services portfolio. Business architecture includes various business and common IT capabilities required or provided over time. IT services architecture includes IT services implemented or improved in the same timeframe to deliver required capabilities. Technology and operations architecture includes set of technologies and practices introduced, upgraded or retired in order to implement required IT services.

In this case, the entries in the matrix are the services defined from the foregoing steps, organized by one or more constraints (for example a gap analysis of the present state of the IT structure and or budget.)

The business architecture sections indicate business goals identified in step 120 in relation to IT capabilities designed to support those capabilities. In this case, a business needs role-based activity dashboard in CY06, point of care access in CY06, and interactive TV-based services in CY08. Likewise, IT capabilities identify the information technology capabilities which are will enable desired business capabilities listed above. For example, Role-based activity dashboard, point of care access and interactive TV-Services can be enabled by role-based access control IT capability. The IT services architecture section includes functional capabilities of various IT services supporting business and IT capabilities, and common services linked (as in column 395 of each service definition) for the functional capabilities.

The technology and operations section illustrates the common practices and actual technologies in use to implement the services. Common practices include a best practices model for the organization including items and capabilities such as on authentication and access control and patch management and auditing. Technologies list the particular actual software or technologies in use to implement the functional capabilities described above. Projects or activities outline events to implement the difference between existing technology and the movement to upgrade for future technologies as desired.

One advantage of the structure of FIG. 10 is that it may be more easily understood by business managers and planners.

In one embodiment, the foregoing process steps may be performed manually. However, it will be understood that each of the service definitions, functional capabilities, and attribute values can be organized into a data structure and that the process of linking can be automated in relation to the data model. The process of linking can be automated by a set of programmatic rules defined in a programming interface. The database can be a relational or object oriented database. One or more preliminary architecture models may be defined and constraints applied against a data model to define modified service portfolios automatically. Likewise, constraints may be applied to limit possible functional capabilities over time, thereby automatically producing the FIG. 10.

It will be further recognized that the methodology and structures defined herein may be updated from time to time. In one embodiment the structures are updated periodically. In another embodiment, the structures are updated based on different events. For example, projects associated with major upgrades to different technologies may drive a re-analysis of the services porfolo in whole or in part.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A method of planning an information technology architecture for a business organization, comprising:
defining an information technology architecture as an information technology (IT) service;
mapping the attributes to other services;
determining future business goals for the organization and for each goal, the information services required to support such goal; and
creating a services portfolio comprising an organization of at least some of said IT services.

2. The method of claim 1 wherein the step of defining includes defining a functional capability for each IT service.

3. The method of claim 2 wherein each functional capability includes at least one attribute.

4. The method of claim 3 wherein said at least one attribute includes an attribute selected from a set of attributed including:
access, delivery, information, transaction, communication, collaboration, consolidation, integration, infrastructure, security, performance, operations and organization.

5. The method of claim 1 wherein the step of mapping includes determining for a given service whether the service consumes or is consumed by another service, and identifying any consumed service in a service definition of a consuming service.

6. The method of claim 1 further including the step, following said mapping step, of creating a preliminary services portfolio model.

7. The method of claim 1 wherein the services portfolio includes at least a subset of functional capabilities of those in the preliminary services portfolio model.

8. The method of claim 1 wherein the step of determining future business goals includes the steps of determining, for a particular business goal:
what content is needed;
who might need the content,
where the content might be needed,
when the content might be needed; and
how the content might be provided.

9. The method of claim 8 wherein each said step of determining is mapped to a particular attribute of an IT service definition.

10. The method of claim 1 further including the step of applying constraints to the services portfolio to define a statement of direction.

11. The method of claim 1 wherein the statement of direction includes a gap analysis.

12. A method of planning an information technology architecture, comprising
building a model services portfolio for a business enterprise comprising a set of services defined by functional capabilities and attributes;
gathering a series of business goals for the organization; and
creating a modified services portfolio based on the forward looking business goals.

13. The method of claim 12 wherein the step of building includes defining each solution in an information technology architecture as an IT service; and mapping the attributes to other services.

14. The method of claim 13 wherein the step of defining includes applying a service definition taxonomy including a functional capability and a set of attributes including access, delivery, information, transaction, communication, collaboration, consolidation, integration, infrastructure, security, performance, operations and organization.

15. The method of claim 13 wherein the step of building a model services portfolio includes determining for a given service whether the service consumes or is consumed by another service, and identifying any consumed service in a service definition of a consuming service.

16. The method of claim 12 wherein the step of gathering includes the steps of determining, for a particular business goal:
what content is needed;
who might need the content,
where the content might be needed,
when the content might be needed; and
how the content might be provided.

17. The method of claim 16 wherein each said step of determining is mapped to a particular attribute of an information service definition.

18. The method of claim 12 further including the step of applying constraints to the services portfolio to define a statement of direction.

19. The method of claim 18 wherein the statement of direction includes a gap analysis.

20. A method for evaluating information technology of a business, comprising:
defining an information technology architecture as an IT service;
mapping the attributes to other services;
creating a model services portfolio;
determining future business goals for the organization and for each goal, the information services required to support such goal; and
creating a modified services portfolio comprising an organization of at least some of said IT services.
